(19) United States
(12) Patent Application Publication
(10) Pub. No.: US 2025/0216624 A1
(43) Pub. Date: Jul. 3, 2025

(54) Comb Laser Source Architectures for Photonic integrated Circuits

(71) Applicant: Intel Corporation, Santa Clara, CA (US)

(72) Inventors: Saeed FATHOLOLOUMI, Los Gatos, CA (US); Ling LIAO, Santa Clara, CA (US); Pegah SEDDIGHIAN, San Jose, CA (US); Faraz MONIFI, Mountain View, CA (US)

(73) Assignee: Intel Corporation, Santa Clara, CA (US)

(21) Appl. No.: 18/399,494

(22) Filed: Dec. 28, 2023

(51) Int. Cl. G02B 6/42; G02B 6/293

(52) U.S. Cl. CPC G02B 6/4206; G02B 6/29344; G02B 6/29386; G02B 6/4215

(57) ABSTRACT

Scalable heterogeneous (hybrid) silicon photonic (SiPh) wavelength division multiplexing laser source architectures suitable as a fiber-coupled external photonic IC (PIC) source for high-bandwidth communication between computing resources. Hybrid-silicon laser sources may be arrayed over a silicon substrate into physically separate banks of lasers, each bank spanning a different range of consecutive wavelength channels and each bank including physically separated odd and even channel groups within a channel range. Optical signals generated by each channel group are passed to a multi-mode interference (MMI) coupler that multiplexes the channel group split across some number of output streams that may be limited to maintain sufficient output power for a given application. The odd channeled multiplexed signals and the even channeled multiplexed signals are passed to interleavers that generate a full spectrum output signal for each bank. Output signals from all banks exit the PIC through an output coupler.

### BACKGROUND

Many computing applications, such as machine learning (ML), can be enhanced through higher bandwidth communication between compute resources. Dense wavelength division multiplexing (DWDM) offers viable solutions toward scaling up and scaling out computation resources as well as enabling the disaggregation of such computation resources. These solutions require low cost, and low power laser sources. DWDM implementations on computing platforms may use external laser sources (ELS) with III-V dies that are externally multiplexed together by separate spatial light circuit (PLC) chips or separate silicon photonic (SiPh) chips. However, such source architectures will likely experience high loss and low yield rendering them prohibitively expensive.

Photonic integrated circuits (PICs) are increasingly important in high-performance computing, data center, and cloud computing applications. The use of silicon in photonics, enables high-volume, low-cost and highly integrated PICs. The provisioning of laser sources is a critical path in DWDM PIC development. A number of promising laser device architectures, including some known as a hybrid silicon lasers, are under development. PIC architectures compatible with integrated lasers and that can implement DWDM sources would therefore be commercially advantageous.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a schematic of a silicon-based PIC laser comb source architecture, in accordance with some embodiments;

FIG. 2 is a plan view of a hybrid-silicon laser suitable for a silicon-based PIC laser comb source architecture, in accordance with some embodiments;

FIG. 3 is a plan view of a multi-mode interference coupler suitable for a silicon-based PIC laser comb source architecture, in accordance with some embodiments;

FIG. 4 is a schematic of one bank in a silicon-based PIC laser comb source, in accordance with some embodiments;

FIG. 5 is a schematic of one bank in a silicon-based PIC laser comb source, in accordance with some alternative embodiments;

FIG. 6 is a schematic of a computation system comprising a silicon-based PIC laser comb source, in accordance with some embodiments; and

FIG. 7 is a functional block diagram of an electronic computing device, that may implement one or more silicon-based PIC laser comb sources, in accordance with some embodiments.

### DETAILED DESCRIPTION

Embodiments are described with reference to the enclosed figures. While specific configurations and arrangements are depicted and discussed in detail, this is done for illustrative purposes only. Persons skilled in the relevant art will recognize that other configurations and arrangements are possible without departing from the spirit and scope of the description. It will be apparent to those skilled in the relevant art that techniques and/or arrangements described herein may be employed in a variety of other systems and applications other than what is described in detail herein.

Reference is made in the following detailed description to the accompanying drawings, which form a part hereof and illustrate exemplary embodiments. Further, it is understood that other embodiments may be utilized and structural and/or logical changes may be made without departing from the scope of claimed subject matter. It should also be noted that directions and references, for example, up, down, top, bottom, and so on, may be used merely to facilitate the description of features in the drawings. Therefore, the following detailed description is not to be taken in a limiting sense and the scope of claimed subject matter is defined solely by the appended claims and their equivalents.

In the following description, numerous details are set forth. However, it will be apparent to one skilled in the art, that embodiments may be practiced without these specific details. In some instances, well-known methods and devices are shown in block diagram form, rather than in detail, to avoid obscuring the embodiments. Reference throughout this specification to “an embodiment” or “one embodiment” or “some embodiments” means that a particular feature, structure, function, or characteristic described in connection with the embodiment is included in at least one embodiment. Thus, the appearances of the phrase “in an embodiment” or “in one embodiment” or “some embodiments” in various places throughout this specification are not necessarily referring to the same embodiment. Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items.

The terms “coupled” and “connected,” along with their derivatives, may be used herein to describe functional or structural relationships between components. These terms are not intended as synonyms for each other. Rather, in particular embodiments, “connected” may be used to indicate that two or more elements are in direct physical, optical, or electrical contact with each other. “Coupled” may be used to indicated that two or more elements are in either direct or indirect (with other intervening elements between them) physical or electrical contact with each other, and/or that the two or more elements co-operate or interact with each other (e.g., as in a cause-and-effect relationship).

The terms “over,” “under,” “between,” and “on” as used herein refer to a relative position of one component or material with respect to other components or materials where such physical relationships are noteworthy. For example, in the context of materials, one material or layer over or under another may be directly in contact or may have one or more intervening materials or layers. Moreover, one material between two materials or layers may be directly in contact with the two materials/layers or may have one or more intervening materials/layers. In contrast, a first material or layer “on” a second material or layer is in direct contact with that second material/layer. Similar distinctions are to be made in the context of component assemblies.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C.

Silicon photonic integrated circuits, as described further below, can provide a highly scalable and low-cost DWDM source. In the embodiments described, arrays of hybrid-lasers are integrated within SiPh optical multiplexing and splitting circuitry. In exemplary embodiments, the described silicon-based source circuitry may advantageously mitigate or avoid challenges stemming from four wave mixing (FWM). Such mixing negatively impacts the optical signal to noise ratio (OSNR) of a given laser line. Accordingly, FWM may limit channel density for a given system. FWM can result from non-linear optical phenomena whereby interactions between two or three wavelengths launched in a PIC produce two or one additional wavelengths as they propagate. A semiconductor optical amplifier (SOA), for example, can generate such satellite peaks.

In accordance with embodiments herein, SOAs within a laser source PIC may be minimized, or even completely avoided, by relying on a multiplicity hybrid-lasers that are physically grouped to leverage the scaling advantages of silicon photonics. Embodiments herein may therefore minimize adverse effects of FWM, improving the OSNR of the laser source. Additionally, by grouping lasers in accordance with embodiments herein, the laser power may be sufficiently low for improved source reliability. In contrast, multi-chip solutions tend to maximize laser power, sacrificing laser reliability. Finally, being based on silicon, laser source photonic circuitry in accordance with embodiments herein can have a higher level of on-chip integration, which translates to a lower chip number and lower cost for a laser source of a given number of channels and/or output power.

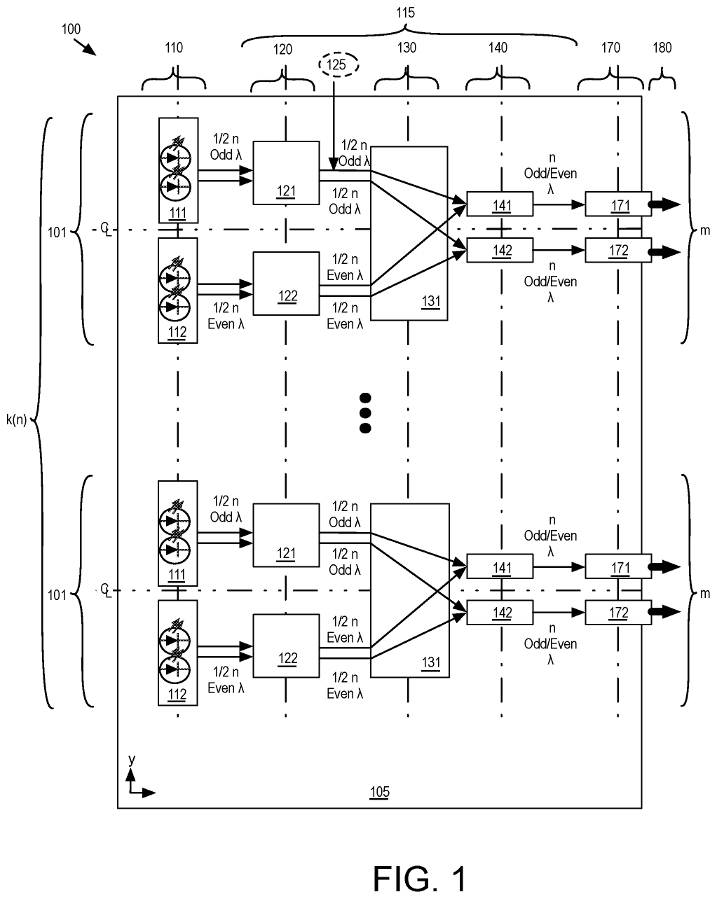

FIG. 1 is a schematic of a silicon-based PIC laser comb source architecture 100, in accordance with some embodiments. Laser comb source architecture 100 is advantageously a single-chip solution, including one monolithic region of a substrate 105. The substrate 105 may have any composition suitable for the fabrication of planar optical waveguides. In advantageous embodiments, substrate 105 comprises one or more layers of silicon. Substrate 105 may include a device material layer of substantially pure monocrystalline silicon. The device material layer may be a top layer of a semiconductor-on-insulator (SOI) substrate material stack further comprising an underlying insulator material layer. In exemplary embodiments where the device material layer is substantially pure silicon, the insulator material is advantageously predominantly silicon and oxygen (e.g., SiO₂). One or more additional substrate material layers may be under, or on a back side of, the insulator material layer as mechanical support. For example, bulk silicon of any thickness (e.g., 20-500 μm) may on the back side of the insulator material. Substrate 105 may alternatively include other materials, such as a monolithic glass layer.

Laser comb source architecture 100 comprises one or more banks 101 of wave division multiplexing photonic circuitry. Each bank 101 includes n light emitters physically arrayed primarily along a first dimension (e.g., y-axis) over a first region of substrate 105. Each bank 101 further includes SiPh circuitry 115 extending primarily along a second, orthogonal, dimension (e.g., x-axis) of substrate 105. As described further below, SiPh circuitry 115 within a bank 101 is to multiplex and split signals launched from emitter array 110 that are grouped within the same bank 101. As shown, laser comb source architecture 100 includes k banks 101. In exemplary embodiments, SiPh circuitry 115 within each bank 101 is substantially the same across all k banks 101. Bank 101 is therefore one atomic unit that may be replicated over substrate 105 as a first scalable characteristic of laser comb source architecture 100.

SiPh circuitry 115 optically couples emitter array 110 to an optical output coupler array 170. Output couplers of array 170 interface laser comb source architecture 100 to external (i.e., off-chip) devices, such as, but not limited to, optical fibers 180. For each bank 101, m composite signals are to be launched from m corresponding output couplers 170. Accordingly, banks 101 may be replicated to generate k(m) composite source signals.

Within a bank 101, light emitters are to output optical signals at n consecutive, or periodic, wavelength channels associated with a center wavelength, or line, λₙ. The number n may vary with implementation (e.g., 8, 12, 16, or 32, etc.). In some exemplary embodiments, the channel wavelengths λ₁-λₙ, span at least a portion of the L-Band (i.e., 1577-1565 nm) and/or at least a portion of C-Band (1564-1530 nm) and/or at least a portion of O-Band (1290-1310 nm) of the electromagnetic spectrum. Channel spacing over λ₁-λₙ may vary with implementation. However, for exemplary DWDM embodiments, channel spacing is less than 1 nm (i.e., <100 GHz) and may be 50 GHz in some examples. As illustrated, light emitters 110 within one bank 101, are physically/spatially grouped together into complementary channel subsets, or groups, 111 and 112. Channel group 111 includes only odd-channeled emitters (e.g., λ₁, λ₃) while channel group 112 includes only even-channeled emitters (e.g., λ₂, λ₄).

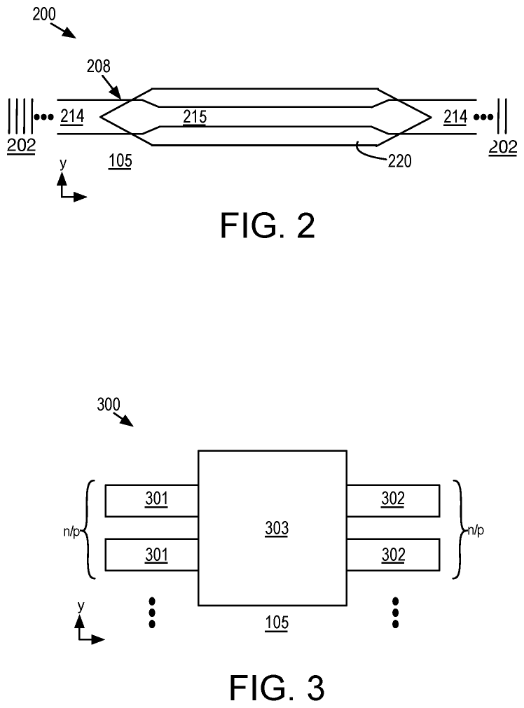

Each laser emitter 110 is advantageously a laser diode, and more specifically a hybrid-silicon laser. FIG. 2 is a plan view of an exemplary hybrid-silicon laser 200, in accordance with some embodiments. Hybrid-silicon laser 200 includes a planar optical waveguide 208, which may be patterned within a device material layer of substrate 105. In exemplary embodiments, waveguide 208 is substantially monocrystalline silicon. Waveguide 208 may have any suitable architecture, such as, but not limited to, a substantially planar ridge waveguide. In the illustrated example, optical waveguide 208 has a substantially constant transverse width (e.g., in y-dimension of substrate 105) over a longitudinal length (e.g., in x-dimension of substrate 105) of an active waveguide region 215. At opposite ends of active waveguide region 215, waveguide 208 tapers out to passive waveguide regions 214 having a larger transverse width. Although the active waveguide width may vary, in some exemplary silicon waveguide embodiments width is in the range of 150 nm to 400 nm. A similar range is also applicable to a z-height of at least active waveguide region 215.

At least a portion of waveguide 208 comprises a mirror for establishing a resonant optical cavity within active waveguide region 215, for example according to any suitable Fabry-Perot (FP) laser architecture. In the illustrated embodiment, grating structures 202 are defined within passive waveguide regions 214 according to any suitable Distributed Bragg Reflector (DBR) laser architecture. In alternative Distributed Feedback (DFB) laser architectures, one or more grating structures 202 may be located within active waveguide region 215.

For laser 200, the term “hybrid” is in reference to a non-silicon (e.g., III-V) material 220 bonded to underlying substrate 105. Material stack 220 may comprise any suitable P-i-N diode material stack, for example including quantum well (QW) or quantum dot (QD) material heterostructures between an n-type material layer and a p-type material layer. Material stack 220 may be Group III-V crystalline alloy material (i.e., a III-V material stack), such as a GaAs/InGaAs heterostructure or InP/InGaP heterostructure, for example.

As further illustrated in FIG. 1, SiPh circuitry 115 comprises a multi-mode interference (MMI) coupler array 120. MMI coupler array 120 is extends primary along the y-dimension of substrate 105, immediately adjacent to emitters 110. Each bank 101 includes at least two MMI couplers of array 120 and may include any number p MMI couplers. Within a bank 101, there may be one more first MMI coupler 121 and one or more second MMI coupler 122. Emitters of odd-channel group 111 are each optically coupled by an optical waveguide to a distinct input port of a multi-mode interference (MMI) coupler 121. Emitters of even-channel group 112 are each optically coupled by an optical waveguide to a distinct input port of a multi-mode interference (MMI) coupler 122.

FIG. 3 is a plan view of an exemplary square MMI coupler 300, in accordance with some embodiments. MMI coupler 300 includes a plurality of input ports 301, each optically coupled to one light emitter. All input ports 301 are optically coupled to all output ports 302 through a multi-mode waveguide 303. MMI coupler 300 therefore is to optically multiplex the signals received at each input port 301 and to power split the multiplexed signals across each output port 302. For architecture 100 (FIG. 1), each of MMI couplers 121 and 122 may be implemented as MMI coupler 300 (FIG. 3) having n/2 input ports and n/2 output ports. For examples where n is 12 and each of odd channel group 111 and even channel group 112 has six emitters, each of MMI couplers 121 and 122 have six input ports and six output ports. In alternative embodiments, MMI coupler array 120 may instead be implemented with a functionally equivalent star coupler.

All optical waveguides within SiPh circuitry 115 may be substantially the same as waveguide 208 and may, for example, comprise substantially pure silicon. In some other embodiments, one or more of the waveguides within SiPh circuitry 115 may instead be predominantly Si and N (e.g., Si₃N₄). Silicon nitride waveguides experience lower non-linear loss than silicon waveguides, and so may be advantageous particularly following multiplexers.

Dividing channels n across even/odd MMI couplers 121, 122 (FIG. 1) limits power division, as well as the number of wavelengths, to one-half n. For some embodiments, SiPh circuitry 115 includes a semiconductor optical amplifier (SOA) 125 optically coupled to each output port of MMI couplers 121, 122. For example, in an embodiment where n is 12, and MMI couplers 121, 122 each have six output ports, laser source architecture 100 may include six SOAs. Each SOA 125 may comprise any suitable gain medium and/or pumping architecture, for example with heterogeneous integration with one or more III-V materials, etc. SOA 125 may compensate for power lost through splitting at MMI couplers 121, 122. Four wave mixing effects associated with SOA 125 may be mitigated by the channel spacing having been increased through the fractional (e.g., one-half) reduction in wavelengths entering each SOA 125 (i.e., as output from each MMI coupler).

For best OSNR, SiPH circuitry 115 does not include an SOA 125. In the absence of any SOA, wavelength groups within bank 101 may be limited according to a predetermined source power output needed for a particular WDM application. For a given bank 101, the number of composite outputs m may therefore be power limited and the number of banks 101 scaled up to arrive at a desired number of composite outputs k(m) for any n channels.

Output ports of MMI coupler array 120 (or, optionally, of a subsequent SOA) are optically coupled through separate planar waveguides that convey signals to input ports of optical interleaver array 140 through one or more waveguide intersection array 130. Two or more planar optical waveguides may cross within waveguide intersection array 130 to route signals of complementary wavelengths to distinct input ports of interleavers 140 where they are further multiplexed in composite signals including both the odd and even channel groups. In the illustrated example, waveguide intersection array 130 comprises a single 2×2 waveguide crossing 131 for each bank 101. Waveguide crossing 131 may have any waveguide crossing architecture suitable for SiPh that displays acceptable cross-talk and/or optical loss. For example, waveguide crossing 131 may be a planar direct crossing, a planar crossing based on multi-mode interference, a planar crossing comprising a resonant cavity, a planar sub-wavelength grating crossing, or any crossing structure comprising a vertical coupler of silicon, silicon nitride, polymer, etc.

Optical interleaver array 140 are similarly extend primarily along one axis (e.g., y-dimension of substrate 105). Interleaver array 140 is to receive n of the multiplexed signals and to output m composite signals, each of which includes all the n channels. Laser source architecture 100 includes a pair of 2×1 interleavers 141, 142. Interleavers 141 and 142 may be substantially identical and have any architecture compatible with SiPh suitable for interleaving odd and even channels into a composite signal including all n channel wavelengths, which is then launch from a single output port. Interleaver architecture may vary with implementation, but in some examples may include a Mach-Zehnder interferometer (MZI). Each interleaver 141, 142 increases the density of the WDM signal to include signals from all emitters in channel groups 111 and 112. Interleaver 141 is to output substantially the same composite signals as interleaver 142. Interleaver 141 is optically coupled (e.g., through a length of passive waveguide) into output coupler 171. Interleaver 142 is similarly optically coupled into output coupler 172.

In the exemplary embodiment, output couplers 171, 172 are part of an array 170 primarily extending along one direction (e.g., y-dimension of substrate 105). Output couplers 171, 172 may each have any suitable vertical or edge (facet) coupler architecture. In the illustrated embodiment, output couplers 171, 172 are each to interface corresponding fibers of an array of optical fibers 180. Each optical fiber may be any known to be suitable for integration with a PIC. The fiber may comprise a single mode (SM) or multi-mode (MM) fiber core. A fiber core may have any suitable composition, but in exemplary embodiments is of a glass suitable for transmission of the band(s) emitted by each bank 101. The glass may be SiO₂, SiO₂ doped with GeO₂, germanosilicate, phosphorus pentoxide, phosphosilicate, Al₂O₃, aluminosilicate, or the like, or any combinations thereof. Along with the fiber core, each optical fiber may include an inner and/or outer claddings axially surrounding the core. In exemplary MM embodiments, the core diameter is approximately 50 μm (e.g., OM3 or OM4 of ISO/IEC 11801). In exemplary SM embodiments, core diameter is less than 10 μm (e.g., ˜9 μm).

In accordance with some embodiments, each bank 101 of PIC laser source architecture 100 may include a greater number of MMI couplers to better maintain high signal power over a given number of channels. Additional MMI couplers may avoid large signal division (e.g., a 6-way power split in a 12-channel source), and thereby advantageously avoid any SOAs. As describe further below, additional MMI couplers can be accommodated by introducing additional interleaver stages to SiPh circuitry 115.

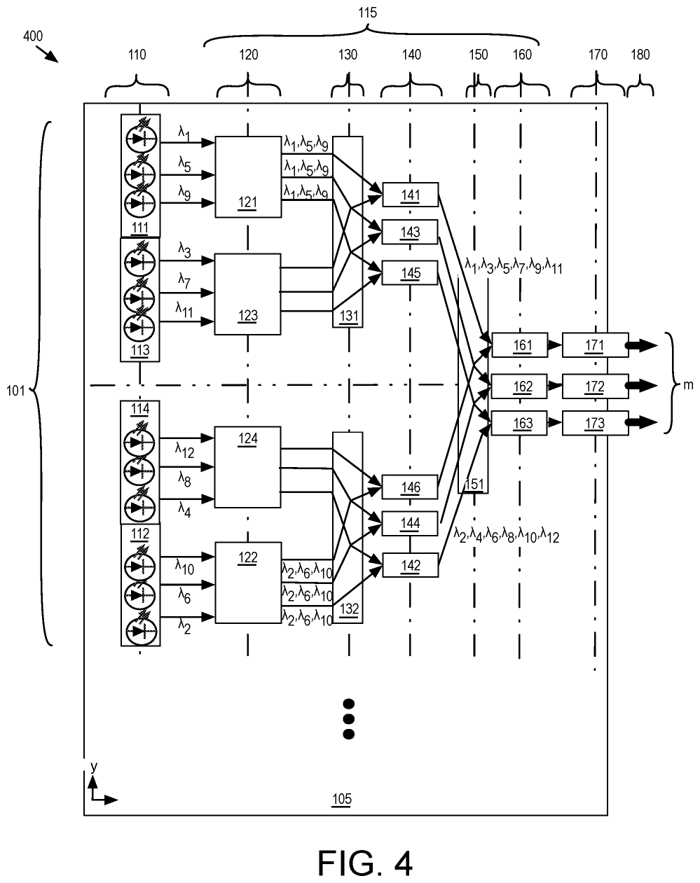

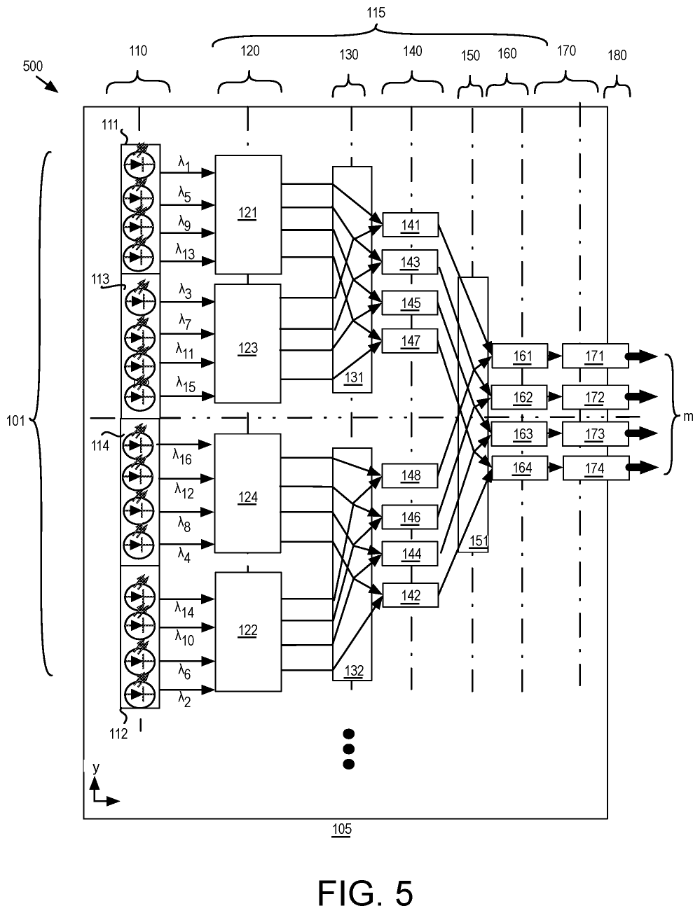

FIG. 4 is a schematic of one bank 101 in a silicon-based PIC laser comb source 400, in accordance with some embodiments. Within comb source 400, bank 101 may again be replicated any number of times to achieve any multiple of m WDM source signals.

Light emitter array 110 is grouped into a plurality of x channel groups. Each channel group therefore includes n/x channels. Channels are distributed across groups to maximize channel spacing within each group. As illustrated in FIG. 4, channel group 111 includes channels λ₁, λ₅, λ₉ and channel group 113 includes channels λ₃, λ₇, λ₁₁. Similarly, channel groups 112 and 114 include complementary channels λ₂, λ₆, λ₁₀ and channels λ₄, λ₈, λ₁₂. Channel groups 111 and 113 are both odd channel groups. Channel groups 112 and 114 are both even channel groups for a total of four channel groups. All channels of each of the groups satisfy the expression: i+4(j) for j of 0 to x−1 for each i^{th} group from 1 to x.

First ones of MMI couplers 120 are coupled to odd-channeled groups and second ones of MMI couplers 120 are coupled to even-channeled groups. Odd channel group 111, for example, is coupled into three input ports of MMI coupler 121. Odd channel group 113 is similarly coupled into three input ports of MMI coupler 123. Even channel groups 112, 114 are each coupled into three input ports of each of MMI coupler 122 and MMI coupler 124, respectively. MMI couplers 121-124 all have a 3×3 architecture, outputting three multiplexed channels split across output three ports (e.g., λ₁, λ₅, λ₉ output of each of three ports of MMI coupler 121).

MMI couplers 121, 123 are optically coupled into a first stage interleaver array 140 through a first stage waveguide intersection 131 so that odd-channeled signals are output into one of three 2×1 odd-channel interleavers 141, 143, 145. MMI couplers 122, 124 are similarly optically coupled into the first stage interleaver array 140 through first waveguide intersection 132 so that even-channeled signals are output into one of three 2×1 even-channel interleavers 142, 144, 146. All MMI couplers 121-124 may have substantially the same architecture, such as any of those described above. All optical interleavers 141-146 may have substantially the same architecture (e.g., comprising an MZI). As illustrated, waveguide intersections 131, 132 each have three waveguide crossings that may be of substantially the same architecture (e.g., any of those described above).

Both odd-channeled interleavers and even-channeled interleavers of array 140 are optically coupled into second stage interleaver array 160 through second stage waveguide intersection array 150. As illustrated, waveguide intersection 151 has three waveguide crossings, all of which may have substantially the same architecture (e.g., any of those described above). Optical interleavers 161-163 may have substantially the same architecture as interleavers 141-146, for example. Each of interleavers 161-163 is an odd-even interleaver with a first input port coupled to one of the odd-channel interleavers 141-145 and a second input port coupled to one of the even-channel interleavers 142-146. Each of interleavers 161-163 is therefore to output a composite of all 6 odd and all 6 even channels to a corresponding one of output couplers 171-173. PIC laser comb source 400 may implement a 12×12 source by arraying a total of four banks 101 over substrate 105 (e.g., along the y-dimension).

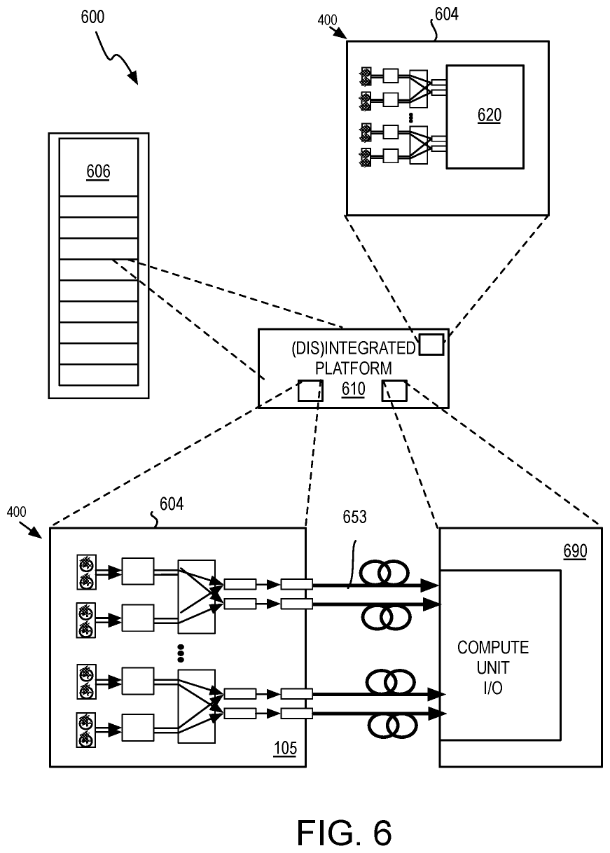

FIG. 5 is a schematic of one bank 101 in a silicon-based PIC laser comb source 500, in accordance with some alternative embodiments suitable for a 16×16 WDM applications. Relative to laser comb source 400, laser comb source 500 illustrates wavelength channel scaling within bank 101.

Arrayed light emitters 110 are grouped into four channel groups with each group scaled up by one light emitter. As illustrated in FIG. 5, odd channel group 111 includes channels λ₁, λ₅, λ₉ and 213. Odd channel group 113 likewise includes channels λ₃, λ₇, λ₁₁ and λ₁₅. Channel groups 112 and 114 include complementary sets of four channels λ₂, λ₆, λ₁₀, λ₁₄ and channels λ₄, λ₈, λ₁₂, λ₁₆.

MMI couplers of MMI coupler array 120 are scaled to have any 4×4 planar architecture suitable for SiPh circuitry. Odd channel group 111, for example, is coupled into four input ports of MMI coupler 121. Odd channel group 113 is coupled into four input ports of MMI coupler 123. Even channel groups 112, 114 are each coupled into four input ports of MMI couplers 122, 124, respectively. Each of MMI couplers 121-124 is to output four multiplexed channels power split across output four ports (e.g., λ₁, λ₅, λ₉ and λ₁₃ output of each of four output ports of MMI coupler 121).

MMI couplers 121, 123 are optically coupled into a first stage interleaver array 140 through a first stage waveguide intersection 131 so that odd-channeled signals are output into one of four 2×1 odd-channel interleavers 141, 143, 145 and 147. MMI couplers 122, 124 are similarly optically coupled into the first stage interleaver array 140 through first waveguide intersection 132 so that even-channeled signals are output into one of four 2×1 even-channel interleavers 142, 144, 146 and 148. All MMI couplers 121-124 may have substantially the same architecture, such as any of those described above. All optical interleavers 141-148 may have substantially the same architecture (e.g., comprising a cascaded imbalanced MZI). As illustrated, waveguide intersections 131, 132 may each have five waveguide crossings. Regardless of the number of crossings to spatially organize (i.e., swizzle) the MMI coupler outputs into interleavable groups, each crossing may be of substantially the same architecture.

Both odd-channeled interleavers and even-channeled interleavers of interleaver array 140 are optically coupled into second stage interleaver array 160 through second stage waveguide intersection 151, which also has five waveguide crossings. Interleaver array 160 is scaled up to include four optical interleavers 161-164, all of which may have substantially the same architecture (e.g., same as interleavers 141-148). Each of interleavers 161-164 is an odd-even interleaver with a first input port coupled to one of the odd-channel interleavers 141-147 and a second input port coupled to one of the even-channel interleavers 142-148. Each of interleavers 161-164 is therefore to output a composite of all 8 odd and all 8 even channels to a corresponding one of output couplers 171-174. PIC laser comb source 400 may therefore implement a 16×16 source by arraying a total of four banks 101 over substrate 105 (e.g., along the y-dimension).

The PICs with one or more banks of WDM source circuitry described herein may be implemented in a wide variety of applications and platforms. FIG. 6 illustrates system 600 including computation platform 606 employing an optical link supplied by WDM source circuitry, for example as described elsewhere herein. Platform 606 may be a commercial server, for example including any number of high-performance computing platforms disposed within a rack and networked together for electronic data processing. Each computing platform may further comprise a plurality of compute units within an integrated or disintegrated platform 610.

Platform 610 further may further include a silicon-based PIC 604. PIC 604 may be one of a plurality of PICs in platform 610, or a stand-alone packaged PIC. PIC 604 includes one or more banks of WDM source circuitry, for example having architecture 100. PIC 604 may include banks 101, for example substantially as described elsewhere herein for PIC 400 or 500. The optical beams generated by banks 101 may be utilized in other photonic circuitry 620 within PIC 604, or may be coupled off-chip to an optical waveguide, wire or fiber 653, for example through top-side coupling or edge coupling of PIC 400. Off-chip waveguide or fiber 653 may further couple to a sink device, such as one or more compute unit 690. In certain embodiments, comb driver circuitry is implemented with CMOS transistors also disposed on the substrate 105. In other embodiments, comb driver circuitry is implemented with CMOS transistors external of substrate 105.

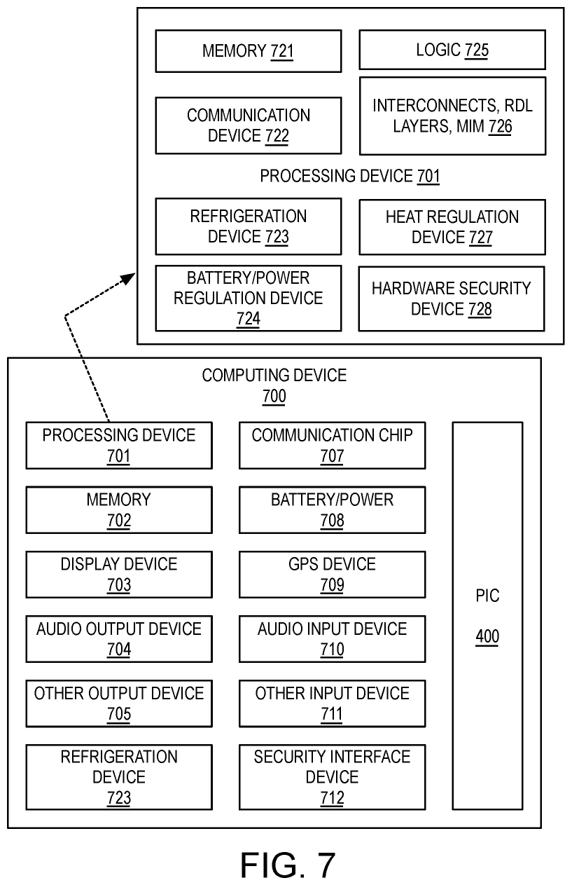

FIG. 7 is a block diagram of a computing device 700 in accordance with some embodiments. For example, one or more components of computing device 700 may include any of the WDM source circuitry discussed elsewhere herein. A number of components are illustrated in FIG. 7 as included in computing device 700, but any one or more of these components may be omitted or duplicated, as suitable for the application. In some embodiments, some of the components included in computing device 700 may be attached to one or more printed circuit boards (e.g., a motherboard). In some embodiments, various ones of these components may be fabricated onto a single system-on-a-chip (SoC) die or implemented with a disintegrated plurality of chiplets or tiles packaged together. Additionally, in various embodiments, computing device 700 may not include one or more of the components illustrated in FIG. 7, but computing device 700 may include interface circuitry for coupling to the one or more components. For example, computing device 700 may not include a display device 703, but may include display device interface circuitry (e.g., a connector and driver circuitry) to which display device 703 may be coupled.

Computing device 700 may include a processing device 701 (e.g., one or more processing devices). As used herein, the term processing device or processor indicates a device that processes electronic data from registers and/or memory to transform that electronic data into other electronic data that may be stored in registers and/or memory. Processing device 701 may include a memory 721, a communication device 722, a refrigeration/active cooling device 723, a battery/power regulation device 724, logic 725, interconnects 726, a heat regulation device 727, and a hardware security device 728.

Processing device 701 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable compute units.

Processing device 701 may include a memory 702, which may itself include one or more memory devices such as volatile memory (e.g., dynamic random-access memory (DRAM)), nonvolatile memory (e.g., read-only memory (ROM)), flash memory, solid state memory, and/or a hard drive. In some embodiments, processing 701 shares a package with memory 702. This memory may be used as cache memory and may include embedded dynamic random-access memory (eDRAM) or spin transfer torque magnetic random-access memory (STT-M RAM).

Computing device 700 may include a heat regulation/refrigeration device 723. Heat regulation/refrigeration device 723 may maintain processing device 701 (and/or other components of computing device 700) at a predetermined low temperature during operation. This predetermined low temperature may be any temperature discussed elsewhere herein.

In some embodiments, computing device 700 may include a communication chip 707 (e.g., one or more communication chips). For example, the communication chip 707 may be configured for managing wireless communications for the transfer of data to and from computing device 700. The term “wireless” and its derivatives may be used to describe circuits, devices, systems, methods, techniques, communications channels, etc., that may communicate data through the use of modulated electromagnetic radiation through a nonsolid medium.

Computing device 700 includes PIC 400, for example having one of the photonic integrated WDM source circuit architectures described herein. PIC 400 may facilitate communication between one or more instances of processing device 701 and/or one or more instances of memory 702.

Computing device 700 may include battery/power circuitry 708. Battery/power circuitry 708 may include one or more energy storage devices (e.g., batteries or capacitors) and/or circuitry for coupling components of computing device 700 to an energy source separate from computing device 700 (e.g., AC line power).

Computing device 700 may include a display device 703 (or corresponding interface circuitry, as discussed above). Display device 703 may include any visual indicators, such as a heads-up display, a computer monitor, a projector, a touchscreen display, a liquid crystal display (LCD), a light-emitting diode display, or a flat panel display, for example.

Computing device 700 may include an audio output device 704 (or corresponding interface circuitry, as discussed above). Audio output device 704 may include any device that generates an audible indicator, such as speakers, headsets, or earbuds, for example.

Computing device 700 may include an audio input device 710 (or corresponding interface circuitry, as discussed above). Audio input device 710 may include any device that generates a signal representative of a sound, such as microphones, microphone arrays, or digital instruments (e.g., instruments having a musical instrument digital interface (MIDI) output).

Computing device 700 may include a global positioning system (GPS) device 709 (or corresponding interface circuitry, as discussed above). GPS device 709 may be in communication with a satellite-based system and may receive a location of computing device 700, as known in the art.

Computing device 700 may include another output device 705 (or corresponding interface circuitry, as discussed above). Examples include an audio codec, a video codec, a printer, a wired or wireless transmitter for providing information to other devices, or an additional storage device.

Computing device 700 may include another input device 711 (or corresponding interface circuitry, as discussed above). Examples may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 700 may include a security interface device 712. Security interface device 712 may include any device that provides security measures for computing device 700 such as intrusion detection, biometric validation, security encode or decode, managing access lists, malware detection, or spyware detection.

Computing device 700, or a subset of its components, may have any appropriate form factor, such as a server or other networked computing component, a mobile device, a printer, a scanner, a monitor, a set-top box, an entertainment control unit, a vehicle control unit, a digital camera, a digital video recorder, or a wearable computing device.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

It will be recognized that practice of the disclosed techniques and architectures is not limited to the embodiments so described but can be modified and altered without departing from the scope of the appended claims. For example, the above embodiments may include specific combinations of features as further provided below.

In some examples, a photonic integrated circuit (PIC) has one or more banks of wave division multiplexing (WDM) source circuitry. Each of the banks of WDM circuitry comprises a plurality of n light emitters over a substrate comprising silicon, the light emitters to output optical signals at n consecutive wavelength channels having a channel spacing therebetween. The WDM circuitry comprises a plurality of m of optical output couplers over the substrate. The WDM circuitry comprises a plurality of p multi-mode interference (MMI) couplers between the light emitters and the output couplers. Each of the MMI couplers is to multiplex n/p optical signals received from a subset of the light emitters and to output n/p multiplexed signals power split across each of n/p ports. The WDM circuitry comprises a plurality of optical interleavers between the MMI couplers and the output couplers. The plurality of interleavers is coupled to receive n of the multiplexed signals and to output m composite signals, each of which includes all the n channels.

In second examples, for any of the first examples each of the light emitters comprise a hybrid silicon laser, n is at least 8, and the channel spacing is less than 200 GHz.

In third examples, for any of the first through second examples the WDM source circuitry comprises a plurality of k banks to output signals from k(m) output couplers.

In fourth examples, the MMI couplers comprise one or more first MMI couplers to receive from a first subset of the emitters odd ones of the channels. One or more second MMI couplers to receive from a second subset of the emitters even ones of the channels.

In fifth examples, for any of the fourth examples the optical interleavers are coupled to interleave multiplexed odd ones of the channels with multiplexed even ones of the channels.

In sixth examples, for any of the fourth through fifth examples the first MMI couplers are each coupled to three or more of the light emitters, the second MMI couplers are each coupled to three or more of the light emitters, and the plurality of interleavers comprises a cascade of two or more stages, wherein a first of the stages comprises three or more interleavers. The n emitters are grouped into a plurality of x channel groups. Each of the groups includes n/x channels, each satisfying an expression: i+4(j) for j of 0 to x−1 for each i^{th} group from 1 to x. The first MMI couplers are each coupled to one of the channel groups with odd ones of the channels. The second MMI couplers are each coupled to one of the channel groups with even ones of the channels. The interleavers comprise odd-channel interleavers coupled to the first MMI couplers, each of the odd-channel interleavers to output a composite of odd ones of the channels. The interleavers comprise even-channel interleavers coupled to the second MMI couplers, each of even-channel interleavers to output a composite of even ones of the channels. The interleavers comprise odd-even interleavers coupled to one of the odd-channel interleavers and one of the even-channel interleavers and to output a composite of odd and even channels.

In eighth examples, for any of the seventh examples n is twelve, x is four, the first MMI couplers comprise a first pair of MMI couplers, each of the first pair coupled to three of the emitters to receive alternating odd ones of the channels and to output three multiplexed signals comprising the alternating odd ones of the channels split across each of a first set of three ports. The second MMI couplers comprise a second pair of MMI couplers, each of the second pair coupled to three of the emitters to receive alternating even ones of the channels and to output three multiplexed signals comprising the alternating even ones of the channels split across each of a second set of three ports. The interleavers comprise three odd-channel interleavers coupled to the first pair of MMI couplers, three even-channel interleavers coupled to the second pair of MMI couplers, and three odd-even interleavers, each coupled to one of the odd-channel interleavers and to one of the even-channel interleavers.

In ninth examples, for any of the seventh examples n is sixteen, x is four, the first MMI couplers comprise a first pair of MMI couplers. Each of the first pair coupled to four of the emitters to receive alternating odd ones of the channels and to output four multiplexed signals comprising the alternating odd ones of the channels power split across each of a first set of four ports. The second MMI couplers comprise a second pair of MMI couplers. Each of the second pair coupled to four of the emitters to receive alternating even ones of the channels and to output four multiplexed signals comprising the alternating even ones of the channels power split across each of a second set of four ports. The interleavers comprise four odd-channel interleavers coupled to the first pair of MMI couplers, four even-channel interleavers coupled to the second pair of MMI couplers, and four odd-even interleavers, each coupled to one of the odd-channel interleavers and to one of the even-channel interleavers.

In tenth examples, for any of the first through ninth examples the interleavers comprise one or more stages, a last of the stages comprises m interleavers, and each of the m interleavers is coupled to an individual one of the m output couplers.

In eleventh examples, for any of the first through tenth examples the emitters are arrayed along a first dimension of the substrate. The MMI couplers are arrayed along the first dimension and adjacent to the emitters. Each of the banks of WDM source circuitry further comprises one or more optical waveguide crossings between the MMI couplers and the interleavers, the waveguide crossings spatially organizing the channels into sets that are to be interleaved.

In twelfth examples for any of the first through eleventh examples no semiconductor optical amplifiers are included in any of the banks of WDM source circuitry.

In thirteenth examples, a laser comb photonic integrated circuit (PIC) comprises a silicon substrate. A plurality of hybrid silicon lasers are arrayed over a first dimension of the substrate, the lasers to output optical signals at consecutive wavelength channels. The PIC comprises a first plurality of planar optical waveguides coupling each of the lasers in two or more channel groups to corresponding multi-mode interference (MMI) couplers, the MMI couplers to multiplex optical signals received from one of the channel groups and to output multiplexed signals power split across each of a number of output ports equal to the number of channels in the channel group. The PIC comprises a second plurality of planar optical waveguides coupling each of the output ports of each of the MMI couplers to first interleavers of the channels of one channel group. The PIC comprises a third plurality of planar optical waveguides coupling each of the first interleavers to a corresponding ones of second interleavers of the channels of two of the channel groups.

In fourteenth examples, for any of the thirteenth examples the channel groups include odd channel groups consisting of odd channels and even channel groups consisting of even channels. A first of the MMI couplers is coupled to one of the odd channel groups. A second of the MMI couplers is coupled to one of the even channel groups. The first interleavers comprise odd-channel interleavers coupled to the first of the MMI couplers and even-channel interleavers coupled to the second of the MMI couplers. The second interleavers comprise odd-even interleavers coupled to one of the odd-channel interleavers and one of the even-channel interleavers, the odd-even interleavers to output a composite signal including the odd and even channels.

In fifteenth examples, for any of the fourteenth examples the PIC further comprises a fourth plurality of planar optical waveguides coupling each of the second interleavers to an optical output coupler, the output coupler to interface an optical fiber to the PIC.

In sixteenth examples, for any of the thirteenth through fifteenth examples at least one of the first, second third or fourth plurality of waveguides comprises a SiN ridge over the substrate.

In seventeenth examples, a photonic system comprises a plurality of optical fibers, and a hybrid silicon laser source coupled to the plurality of optical fibers. The laser source comprises a plurality of banks of wave division multiplexing (WDM) source circuitry over a silicon substrate. Each of the banks further comprises a plurality of hybrid Si-Group III-V lasers over a substrate comprising silicon. The lasers are to output optical signals at a number of consecutive wavelength channels. The lasers physically grouped over the substrate into odd channeled sets and even channeled sets. The laser source comprises a plurality of multi-mode interference (MMI) couplers adjacent to, and optically coupled to, one of the odd and even channeled sets of the lasers, the MMI couplers to multiplex optical signals into a plurality of odd or even channeled multiplexed signals. The laser source comprises a plurality of optical interleavers adjacent to, and optically coupled to, the MMI couplers, the interleavers to combine the odd channeled multiplexed signals with the even channeled multiplexed signals into composite output signals. The laser source comprises a plurality of output couplers interfacing with the optical fibers to convey the output signals off the silicon substrate.

In eighteenth examples, for any of the seventeenth examples the system further comprises an optical isolator coupled to each of the optical fibers.

In nineteenth examples, for any of the seventeenth through eighteenth examples the system comprises a semiconductor optical amplifier between any coupled pairing of: the lasers and the MMI couplers, the MMI couplers and the interleavers, or the interleavers and the output couplers.

In twentieth examples, for any of the seventeenth through nineteenth examples the WDM source circuitry comprises two or more of the banks, wherein each of the banks spans a different number of consecutive wavelength channels, and wherein each of the banks comprises 8, 12, 16, or 32 lasers.

However, the above embodiments are not limited in this regard, and, in various implementations, the above embodiments may include the undertaking of only a subset of such features, undertaking a different order of such features, undertaking a different combination of such features, and/or undertaking additional features than those features explicitly listed. The scope of the disclosed techniques and architectures should therefore be determined with reference to the appended claims, along with the full scope of equivalents to which such claims are entitled.

What is claimed is:

1. A photonic integrated circuit (PIC) with one or more banks of wave division multiplexing (WDM) source circuitry, wherein each of the banks of WDM circuitry comprises:
a plurality of n light emitters over a substrate comprising silicon, the light emitters to output optical signals at n consecutive wavelength channels having a channel spacing therebetween;
a plurality of m of optical output couplers over the substrate;
a plurality of p multi-mode interference (MMI) couplers between the light emitters and the output couplers, wherein each of the MMI couplers is to multiplex n/p optical signals received from a subset of the light emitters and to output n/p multiplexed signals power split across each of n/p ports; and
a plurality of optical interleavers between the MMI couplers and the output couplers, wherein the plurality of interleavers is coupled to receive n of the multiplexed signals and to output m composite signals, each of which includes all the n channels.

2. The PIC of claim 1, wherein:
each of the light emitters comprise a hybrid silicon laser;
n is at least 8; and
the channel spacing is less than 200 GHz.

3. The PIC of claim 2, wherein:
the WDM source circuitry comprises a plurality of k banks to output signals from k(m) output couplers.

4. The PIC of claim 1, wherein the MMI couplers comprise:
one or more first MMI couplers to receive from a first subset of the emitters odd ones of the channels; and
one or more second MMI couplers to receive from a second subset of the emitters even ones of the channels.

5. The PIC of claim 4, wherein the optical interleavers are coupled to interleave multiplexed odd ones of the channels with multiplexed even ones of the channels.

6. The PIC of claim 4, wherein:
the first MMI couplers are each coupled to three or more of the light emitters;
the second MMI couplers are each coupled to three or more of the light emitters; and
the plurality of interleavers comprises a cascade of two or more stages, wherein a first of the stages comprises three or more interleavers.

7. The PIC of claim 4, wherein:
the n emitters are grouped into a plurality of x channel groups, wherein each of the groups includes n/x channels, each satisfying an expression: i+4(j) for j of 0 to x−1 for each i^{th} group from 1 to x;
the first MMI couplers are each coupled to one of the channel groups with odd ones of the channels;
the second MMI couplers are each coupled to one of the channel groups with even ones of the channels; and
the interleavers comprise:
odd-channel interleavers coupled to the first MMI couplers, each of the odd-channel interleavers to output a composite of odd ones of the channels;
even-channel interleavers coupled to the second MMI couplers, each of even-channel interleavers to output a composite of even ones of the channels; and
odd-even interleavers coupled to one of the odd-channel interleavers and one of the even-channel interleavers and to output a composite of odd and even channels.

8. The PIC of claim 7, wherein:
n is twelve;
x is four;
the first MMI couplers comprise a first pair of MMI couplers, each of the first pair coupled to three of the emitters to receive alternating odd ones of the channels and to output three multiplexed signals comprising the alternating odd ones of the channels split across each of a first set of three ports;
the second MMI couplers comprise a second pair of MMI couplers, each of the second pair coupled to three of the emitters to receive alternating even ones of the channels and to output three multiplexed signals comprising the alternating even ones of the channels split across each of a second set of three ports; and
the interleavers comprise:
three odd-channel interleavers coupled to the first pair of MMI couplers;
three even-channel interleavers coupled to the second pair of MMI couplers; and
three odd-even interleavers, each coupled to one of the odd-channel interleavers and to one of the even-channel interleavers.

9. The PIC of claim 7, wherein:
n is sixteen;
x is four;
the first MMI couplers comprise a first pair of MMI couplers, each of the first pair coupled to four of the emitters to receive alternating odd ones of the channels and to output four multiplexed signals comprising the alternating odd ones of the channels power split across each of a first set of four ports;
the second MMI couplers comprise a second pair of MMI couplers, each of the second pair coupled to four of the emitters to receive alternating even ones of the channels and to output four multiplexed signals comprising the alternating even ones of the channels power split across each of a second set of four ports; and
the interleavers comprise:
four odd-channel interleavers coupled to the first pair of MMI couplers;
four even-channel interleavers coupled to the second pair of MMI couplers; and
four odd-even interleavers, each coupled to one of the odd-channel interleavers and to one of the even-channel interleavers.

10. The PIC of claim 1, wherein the interleavers comprise one or more stages, and wherein a last of the stages comprises m interleavers, and wherein each of the m interleavers is coupled to an individual one of the m output couplers.

11. The PIC of claim 1, wherein:
the emitters are arrayed along a first dimension of the substrate;
the MMI couplers are arrayed along the first dimension and adjacent to the emitters; and
each of the banks of WDM source circuitry further comprises one or more optical waveguide crossings between the MMI couplers and the interleavers, the waveguide crossings spatially organizing the channels into sets that are to be interleaved.

12. The PIC of claim 1, wherein no semiconductor optical amplifiers are included in any of the banks of WDM source circuitry.

13. A laser comb photonic integrated circuit (PIC), comprising:
a silicon substrate;
a plurality of hybrid silicon lasers arrayed over a first dimension of the substrate, the lasers to output optical signals at consecutive wavelength channels;
a first plurality of planar optical waveguides coupling each of the lasers in two or more channel groups to corresponding multi-mode interference (MMI) couplers, the MMI couplers to multiplex optical signals received from one of the channel groups and to output multiplexed signals power split across each of a number of output ports equal to the number of channels in the channel group;
a second plurality of planar optical waveguides coupling each of the output ports of each of the MMI couplers to first interleavers of the channels of one channel group;
a third plurality of planar optical waveguides coupling each of the first interleavers to a corresponding ones of second interleavers of the channels of two of the channel groups.

14. The PIC of claim 13, wherein:
the channel groups include odd channel groups consisting of odd channels and even channel groups consisting of even channels;
a first of the MMI couplers is coupled to one of the odd channel groups;
a second of the MMI couplers is coupled to one of the even channel groups;
the first interleavers comprise odd-channel interleavers coupled to the first of the MMI couplers and even-channel interleavers coupled to the second of the MMI couplers; and
the second interleavers comprise odd-even interleavers coupled to one of the odd-channel interleavers and one of the even-channel interleavers, the odd-even interleavers to output a composite signal including the odd and even channels.

15. The PIC of claim 14, further comprising a fourth plurality of planar optical waveguides coupling each of the second interleavers to an optical output coupler, the output coupler to interface an optical fiber to the PIC.

16. The PIC of claim 13, wherein at least one of the first, second third or fourth plurality of waveguides comprises a SiN ridge over the substrate.

17. A photonic system, comprising:
a plurality of optical fibers; and
a hybrid silicon laser source coupled to the plurality of optical fibers, wherein the laser source comprises a plurality of banks of wave division multiplexing (WDM) source circuitry over a silicon substrate, wherein each of the banks further comprises:
a plurality of hybrid Si-Group III-V lasers over a substrate comprising silicon, the lasers to output optical signals at a number of consecutive wavelength channels, the lasers physically grouped over the substrate into odd channeled sets and even channeled sets;
a plurality of multi-mode interference (MMI) couplers adjacent to, and optically coupled to, one of the odd and even channeled sets of the lasers, the MMI couplers to multiplex optical signals into a plurality of odd or even channeled multiplexed signals;
a plurality of optical interleavers adjacent to, and optically coupled to, the MMI couplers, the interleavers to combine the odd channeled multiplexed signals with the even channeled multiplexed signals into composite output signals; and
a plurality of output couplers interfacing with the optical fibers to convey the output signals off the silicon substrate.

18. The photonic system of claim 17, further comprising an optical isolator coupled to each of the optical fibers.

19. The photonic system of claim 17, further comprising a semiconductor optical amplifier between any coupled pairing of: the lasers and the MMI couplers, the MMI couplers and the interleavers, or the interleavers and the output couplers.

20. The photonic system of claim 17, wherein the WDM source circuitry comprises two or more of the banks, wherein each of the banks spans a different number of consecutive wavelength channels, and wherein each of the banks comprises 8, 12, 16, or 32 lasers.
